(19) United States
(12) Patent Application Publication
(10) Pub. No.: US 2026/0254872 A1
(43) Pub. Date: Aug. 27, 2026

(54) DATA ACCESS METHOD, SYSTEM, DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Long QIAN, Hangzhou, Zhejiang (CN); Wu QIN, Hangzhou, Zhejiang (CN); Zhengheng WANG, Hangzhou, Zhejiang (CN); Guoyun ZHU, Hangzhou, Zhejiang (CN)

(21) Appl. No.: 19/162,014

(22) PCT Filed: Apr. 26, 2024
(86) PCT No.: PCT/CN2024/090133

§ 371 Date: Sep. 3, 2025

(30) Foreign Application Priority Data
May 22, 2023 (CN) 202310581803.X

(51) Int. Cl. H04L 67/1097

(52) U.S. Cl. CPC H04L 67/1097

(57) ABSTRACT

At least one embodiment of the present disclosure provides a data access method, a system, a device, and a storage medium. The data access method includes that: it is determined, in response to an access request, whether target data indicated by the access request is cached locally; the access request is sent to a storage node in response to the target data being not cached locally, to receive the target data and a version number of the target data returned by the storage node, and cache the target data and the version number of the target data locally; and, in response to the target data being cached locally, the target data cached locally is read when it is determined that the version number of the target data cached locally is consistent with the version number of the target data stored in the storage node.

The present disclosure claims priority of Chinese Patent Application No. 202310581803.X, filed to China National Intellectual Property Administration on May 22, 2023 and titled “DATA ACCESS METHOD, SYSTEM, DEVICE, AND STORAGE MEDIUM”, the content of which is hereby incorporated by reference in its entirety.

### TECHNICAL FIELD

At least one embodiment of the present disclosure relates to the technical field of data access, and particularly, to a data access method, a system, a device, and a storage medium.

### BACKGROUND OF THE INVENTION

In a data access system in the related art, data is stored in one or more storage nodes, and different access terminals can access any one of the storage nodes to read desired data from this storage node according to actual access requirements.

When a specific piece of data in one storage node is frequently accessed, the load on this storage node increases, leading to a performance bottleneck of this storage node. As a result, some access terminals attempting to read this specific piece of data may experience significant delays.

### SUMMARY OF THE INVENTION

In view of this, at least one embodiment of the present disclosure provides a data access method, a system, a device, and a storage medium.

To achieve the foregoing objectives, at least one embodiment of the present disclosure provides the following technical solutions.

According to a first aspect of at least one embodiment of the present disclosure, a data access method is provided, which is applied to an access terminal. The data access method includes the following steps. It is determined, in response to an access request, whether target data indicated by the access request is cached locally. The access request is sent to a storage node in response to the target data being not cached locally, to receive the target data and a version number of the target data returned by the storage node, and cache the target data and the version number of the target data locally, where a version number of any piece of data stored in the storage node is modified based on a modification operation performed on this piece of data. In response to the target data being cached locally, the target data cached locally is read when it is determined that the version number of the target data cached locally is consistent with the version number of the target data stored in the storage node, and the access request is sent to the storage node when it is determined that the version number of the target data cached locally is inconsistent with the version number of the target data stored in the storage node.

According to a second aspect of at least one embodiment of the present disclosure, a data access method is provided, which is applied to a storage node. The data access method includes the following steps. An access request sent by any access terminal is received, and target data indicated by the access request is determined. The target data and a version number of the target data are returned to the access terminal, to allow the access terminal to cache the target data and the version number of the target data locally, where a version number of any piece of data stored in the storage node is modified based on a modification operation performed on this piece of data; and the target data and the version number of the target data are used for allowing the access terminal to read, when receiving another access request for the target data, the target data cached locally when it is determined that the version number of the target data cached locally is consistent with the version number of the target data stored in the storage node.

According to a third aspect of the embodiments of the present disclosure, a data access method is provided, which is applied to a storage node. Any storage node is configured to cache at least one piece of data and a version number of the at least one piece of data stored in this storage node in another storage node, and notify an access terminal; and/or receive at least one piece of data and a version number of the at least one piece of data sent by the other storage node, and store the at least one piece of data and the version number locally. A version number of any piece of data stored in the storage node is modified based on a modification operation performed on this piece of data. The data access method includes the following steps. An access request sent by any access terminal is received, and it is determined whether target data indicated by the access request is cached in the storage node by the other storage node. The target data is returned to the access terminal in response to determining that the target data is not cached in the storage node by the other storage node; and, in response to determining that the target data is cached in the storage node by the other storage node, the target data cached locally is returned to the access terminal when it is determined that the version number of the target data stored in the storage node is consistent with the version number of the target data stored in the other storage node.

According to a fourth aspect of the embodiments of the present disclosure, a data access system is provided, which includes at least one access terminal and at least one storage node. Any storage node is configured to receive an access request sent by any access terminal, determine target data indicated by the access request, and return the target data and a version number of the target data to this access terminal, where a version number of any piece of data stored in each storage node is modified based on a modification operation performed on this piece of data. Any access terminal is configured to determine, in response to an access request, whether target data indicated by the access request is cached locally; and send the access request to a storage node in response to the target data being not cached locally, to receive the target data and a version number of the target data returned by this storage node, and cache the target data and the version number of the target data locally; and read, in response to the target data being cached locally, the target data cached locally when it is determined that the version number of the target data cached locally is consistent with the version number of the target data stored in the storage node, and send the access request to the storage node when it is determined that the version number of the target data cached locally is inconsistent with the version number of the target data stored in the storage node.

According to a fifth aspect of the embodiments of the present disclosure, a data access system is provided, which includes at least one access terminal and at least two storage nodes. Any storage node is configured to cache at least one piece of data and a version number of the at least one piece of data stored in this storage node in another storage node, and notify an access terminal; and/or receive at least one piece of data and a version number of the at least one piece of data sent by the other storage node, and store the at least one piece of data and the version number sent by the other storage node locally, where a version number of any piece of data stored in each storage node is modified based on a modification operation performed on this piece of data. Any access terminal is configured to send an access request to a storage node. Any storage node is further configured to receive the access request sent by any access terminal, and determine whether the target data indicated by the access request is cached in the storage node by the other storage node, return the target data to this access terminal in response to determining that the target data is not cached in the storage node by the other storage node, and return, in response to determining that the target data is cached in the storage node by the other storage node, the target data cached locally to this access terminal when it is determined that the version number of the target data stored in the storage node is consistent with the version number of the target data stored in the other storage node.

According to a sixth aspect of the embodiments of the present disclosure, an electronic device is provided, which includes: a processor; and a memory configured to store executable instructions of the processor, where when executing the executable instructions, the processor is configured to implement the data access method in the first aspect.

According to a seventh aspect of the embodiments of the present disclosure, a computer-readable storage medium is provided, which stores a computer program. The computer program, when executed by a processor, implements the steps of the data access method in any one of the foregoing aspects.

It should be understood that the foregoing general description and the following detailed description are exemplary and illustrative, and are not intended to limit the present disclosure.

### BRIEF DESCRIPTION OF DRAWINGS

FIG. 1 is a structural schematic diagram of a first data access system according to some exemplary embodiments.

FIG. 2 is a structural schematic diagram of a second data access system according to some exemplary embodiments.

FIG. 3 is a sequence chart of a data access process according to some exemplary embodiments.

FIG. 4 is a structural schematic diagram of a third data access system according to some exemplary embodiments.

FIG. 5 is a structural schematic diagram of a fourth data access system according to some exemplary embodiments.

FIG. 6 is a schematic flowchart of a data access method according to some exemplary embodiments.

FIG. 7A is a schematic flowchart of another data access method according to some exemplary embodiments.

FIG. 7B is a schematic flowchart of still another data access method according to some exemplary embodiments.

FIG. 8 is a structural schematic diagram of a device according to some exemplary embodiments.

### DETAILED DESCRIPTION OF THE INVENTION

Exemplary embodiments are described in detail here, which are exemplarily shown in the drawings. In the following description with reference to the drawings, unless otherwise indicated, the same reference numerals in different figures denote the same or similar elements. The implementations described in the following exemplary embodiments do not represent all implementations consistent with at least one embodiment of the present disclosure. On the contrary, these implementations are examples of apparatuses and methods consistent with some aspects of at least one embodiment of the present disclosure, as detailed in the appended claims.

It should be noted that in other embodiments, the steps of the corresponding method may not necessarily be executed in the order shown and described in the present disclosure. In some other embodiments, the data access method may include more or fewer steps than those described in the present disclosure. In addition, a single step described in the present disclosure is decomposed into multiple steps in another embodiment, while multiple steps described in the present disclosure are combined into a single step in other embodiments.

In the related art, data is stored in at least one storage node. A data table in a database is taken as some examples, and data in the data table is distributed across different storage nodes based on sharding rules. Different access terminals may access any storage node according to actual access requirements and read required data from the storage node. When a specific piece of data in one storage node is frequently accessed, load on the storage node is increased, resulting in a performance bottleneck of the storage node. As a result, some access terminals requesting the data may experience prolonged wait time. A storage node is a software product integrated in a physical device, and one physical device may integrate at least one storage node. This is not limited in some embodiments.

In the related art, a solution to address increased load on a storage node is introduced as follows. Hot data is cached on an access terminal, and then the cached hot data is invalidated by using an asynchronous notification scheme. For example, the access terminal may subscribe to a data invalidation message and acquire hot data information. The access terminal requests data A from a server, and caches a returned value of A in a local internal memory when A is hot data. When receiving a request for reading A again, the access terminal directly returns a result cached in the internal memory to avoid a request to the server, thereby reducing traffic for hot data A. When A is modified, the server asynchronously sends an invalidation message for A to the access terminal, and the access terminal deletes the local cache. Upon subsequently requesting A, the access terminal will request latest data from the server again. Because in this solution, the invalidation message for A is sent asynchronously, the access terminal will read an inconsistent result during the period from the time when A is modified to the time when the invalidation message for A is received. Furthermore, because the server and the access terminal are not located on the same machine, communication between the server and the access terminal may experience anomalies such as disconnection or packet loss. When the server fails to notify all access terminals timely after A is modified, data consistency cannot be ensured.

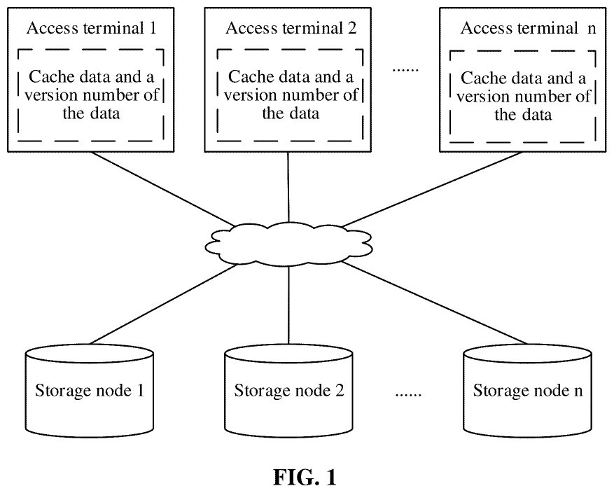

In view of the problems in the related art, referring to FIG. 1, some embodiments of the present disclosure provide a data access system, which includes at least one access terminal and at least one storage node. n in FIG. 1 is an integer greater than 0. Any storage node is configured to store at least one piece of data and a version number of each piece of data; and a version number of any piece of data is modified based on a modification operation performed on the piece of data. A data table in a database is taken as some examples, one piece of data here indicates one row of data in the data table, and after one value in the row of data is modified, a version number of the row of data is modified. In another scenario such as a function call scenario, one piece of data refers to values of all input parameters of a particular function. Data definition is not limited in some embodiments, and can be specifically set according to an actual application scenario.

Any one of the storage nodes is further configured to receive an access request sent by any access terminal, and determine target data indicated by the access request; and return the target data and a version number of the target data to the access terminal.

Any one of the access terminals is configured to determine, in response to an access request, whether target data indicated by the access request is cached locally; and send the access request to a storage node in response to the target data being not cached locally, to receive the target data and a version number of the target data returned by the storage node, and cache the target data and the version number of the target data locally; or read, in response to the target data being cached locally, the target data cached locally when it is determined that the version number of the target data cached locally is consistent with the version number of the target data stored in the storage node, or send the access request to the storage node when it is determined that the version number of the target data cached locally is inconsistent with the version number of the target data stored in the storage node.

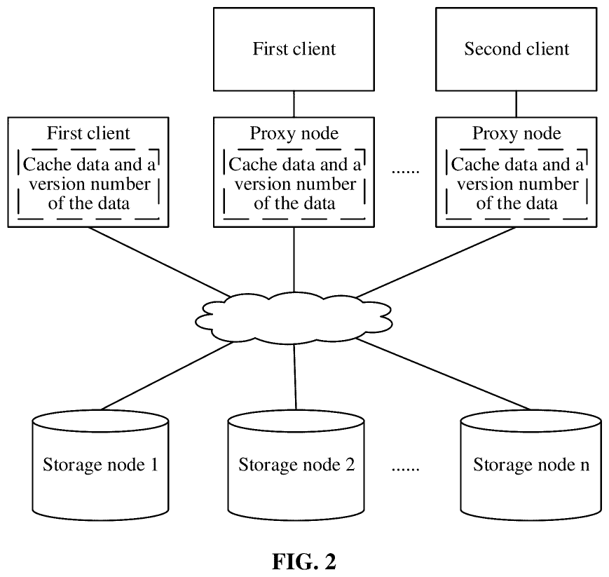

In some embodiments, the access terminal can cache the target data, and can directly read the target data cached locally in response to a subsequent request for the same data, without acquiring the target data from the storage node. In this way, the load on the storage node is reduced. Furthermore, in view of the problem of invalidation of the target data stored in the access terminal caused by modification of the target data stored in the storage node, to avoid incorrect reading of the invalid target data by the access terminal, a version number check method is further provided. The storage node returns the target data and the version number of the target data together. The access terminal can cache the target data and the version number of the target data, and can directly read the target data cached locally when it is determined that the version number of the target data cached locally is consistent with the version number of the target data stored in the storage node, which indicates that the target data cached in the access terminal is latest valid data. In this way, accuracy and strong consistency of data reading are ensured. In some embodiments, referring to FIG. 2, the access terminal includes a proxy node and a first client. The proxy node is capable of communicating with the first client or a second client. Exemplarily, the proxy node can receive an access request sent by the first client, and forward the access request to a storage node; and return target data indicated by the access request to the first client after acquiring the target data indicated by the access request. Exemplarily, the proxy node can receive an access request sent by the second client, and forward the access request to a storage node; and return target data indicated by the access request to the second client after acquiring the target data indicated by the access request.

In a possible scenario, the proxy node, the first client, and the storage node are maintained by the same manufacturer, development personnel of the manufacturer can modify code of the proxy node or the first client, to enable the modified proxy node and the modified first client to achieve the foregoing functions. The second client is an open-source client or maintained by another manufacturer, code of the second client cannot be modified, and the second client accesses the storage node through the modified proxy node. Certainly, the first client can also access the storage node through the modified proxy node. This is not limited in some embodiments.

In another possible scenario, the proxy node, the first client, and the storage node are alternatively maintained by different manufacturers, and code can be modified by the different manufacturers through negotiation to implement the functions provided by the embodiments of the present disclosure. This is not limited in some embodiments.

In some possible implementations, a version number check process can be performed on the access terminal to reduce the load on the storage node caused by a check operation. Exemplarily, the access terminal is located on a device equipped with a first RDMA (remote direct memory access) network card, and the storage node is located on a device equipped with a second RDMA network card. In the RDMA technology, data is directly transferred into a storage area of a computer over a network, and the data is quickly moved from one system to a memory of a remote system without causing any impact on an operating system. In this way, minimal processing power of the computer is required.

Any one of the storage nodes is further configured to receive an access request sent by any access terminal, and determine target data indicated by the access request; and return the target data, a version number of the target data, and a storage address of the version number to the access terminal.

Any access terminal is further configured to determine, in response to an access request, whether target data indicated by the access request is cached locally; and send the access request to a storage node in response to the target data being not cached locally, to receive the target data, a version number of the target data, and a storage address of the version number returned by the storage node, and cache the target data, the version number of the target data, and the storage address of the version number locally; or send a first check request to the second RDMA network card through the first RDMA network card in response to the target data being cached locally, the first check request carrying the storage address of the version number of the target data, to allow the second RDMA network card to read the version number of the target data stored in the storage node from the storage address and return the version number; and read the target data cached locally when it is determined that the version number of the target data cached locally is consistent with the version number returned by the second RDMA network card, or send the access request to the storage node when it is determined that the version number of the target data cached locally is inconsistent with the version number returned by the second RDMA network card.

In some embodiments, through the RDMA technology, the second RDMA network card of the storage node directly reads the version number from the storage address without the need of a processor (such as a CPU) of the storage node, and returns the version number. In this way, the load on the processor of the storage node can be significantly reduced.

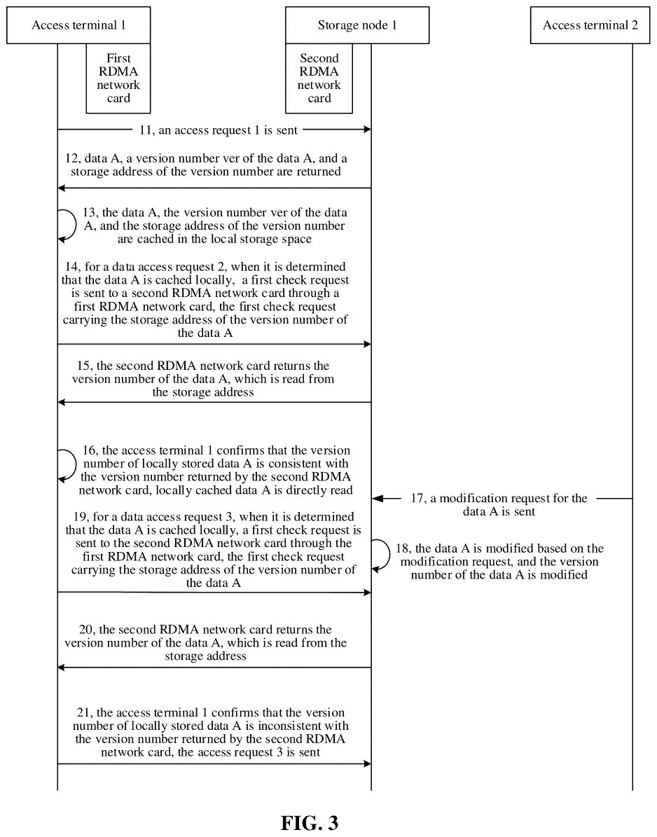

In some examples, a sequence chart of a data access system is shown in FIG. 3.

In step 11, at time T1, when an access terminal 1 has a data access request 1 for requesting data A, and the data A is not cached in a local storage space of the access terminal 1, the access terminal 1 sends the access request 1 to a storage node 1.

In step 12, the storage node 1 returns the data A (assuming that A=1), a version number ver (assuming that ver=5) of the data A, and a storage address of the version number to the access terminal 1 in response to the access request 1.

In step 13, the access terminal 1 caches the data A (A=1), the version number ver (ver=5) of the data A, and the storage address of the version number returned by the storage node 1, in the local storage space.

In step 14, at time T2, when the access terminal 1 has a requirement for requesting the data A again, that is, a data access request 2 for requesting the data A exists, when it is determined that the data A is cached locally, the access terminal 1 sends a first check request to a second RDMA network card through a first RDMA network card, the first check request carrying the storage address of the version number of the data A.

In step 15, the second RDMA network card directly reads the version number of the data A stored in the storage node from the storage address and returns the version number.

In step 16, when the access terminal 1 confirms that the version number of locally stored data A is consistent with the version number returned by the second RDMA network card, the access terminal 1 directly reads locally cached data A.

In step 17, at time T3, an access terminal 2 sends a modification request for the data A to the storage node 1, to request modification of A=1 to A=2.

In step 18, the storage node 1 modifies the data A based on the modification request, and modifies the version number (assuming that the version number is modified to ver=6) of the data A.

In step 19, at time T4, the access terminal 1 has a requirement for requesting the data A again, that is, a data access request 3 for requesting the data A exists. When it is determined that the data A is cached locally, the access terminal 1 sends a first check request to the second RDMA network card through the first RDMA network card, the first check request carrying the storage address of the version number of the data A.

In step 20, the second RDMA network card directly reads the version number of the data A stored in the storage node from the storage address and returns the version number.

In step 21, when the access terminal 1 confirms that the version number (ver=5) of locally stored data A is inconsistent with the version number (ver=6) returned by the second RDMA network card, the access terminal 1 sends the access request 3 to the storage node 1.

In some possible implementations, the version number check process is alternatively performed on the storage node. Any one of the storage nodes is further configured to receive an access request sent by any access terminal, and determine target data indicated by the access request; and return the target data and a version number of the target data to the access terminal, where a version number of any piece of data stored in the storage node is modified based on a modification operation performed on the piece of data.

Any one of the access terminals is configured to determine, in response to an access request, whether target data indicated by the access request is cached locally; and send the access request to a storage node in response to the target data being not cached locally, to receive the target data and a version number of the target data returned by the storage node, and cache the target data and the version number of the target data locally; or send a second check request to the storage node in response to the target data being cached locally, the second check request carrying the version number of the target data cached locally.

Any one of the storage nodes is further configured to receive a second check request sent by any access terminal, compare the version number of target data carried in the second check request with the version number of the target data stored in the storage node, and return consistency confirmation information to the access terminal when the version number of the target data carried in the second check request is consistent with the version number of the target data stored in the storage node, to allow the access terminal to read the target data cached locally in the access terminal; or return inconsistency confirmation information to the access terminal when the two version numbers are inconsistent, to allow the access terminal to send an access request to this storage node.

In some embodiments, when the version numbers are verified to be consistent, the access terminal does not need to read data from the storage node. In this way, the load on the storage node is reduced, and meanwhile, strong consistency of data is ensured.

In some embodiments, considering that particular data has low access frequency, caching such data in the access terminal results in a low probability of subsequent access by the access terminal, thereby leading to a waste of storage resources on the access terminal. Therefore, any storage node is further configured to determine whether target data indicated by the access request is hot data after receiving the access request sent by any access terminal, the hot data being data accessed frequently. For example, an access count of the target data within a unit time exceeds a preset threshold, the target data is determined as hot data; or if the access count of the target data within the unit time is greater than a statistical value of access counts of other data within the unit time, the target data is determined as hot data. The preset threshold can be specifically configured according to an actual application scenario. This is not limited in some embodiments. The statistical value of access counts of other data includes, but is not limited to, an average value, a median value, a maximum value, or the like.

Any one of the storage nodes is further configured to return the target data and a version number of the target data to the access terminal when the target data is determined as hot data; and directly return the target data to the access terminal if the target data is not the hot data. In some embodiments, hot data of a specific storage node is stored in the access terminal. In this way, the load on the storage node caused by hot data access is reduced.

The present disclosure provides a data access system. Any storage node is configured to store at least one piece of data and a version number of each piece of data; and a version number of any piece of data is modified based on a modification operation performed on the piece of data. In this way, modification of the data and modification of the version number can be performed synchronously, to ensure the consistency. An access terminal caches target data and a version number of the target data, performs version number check before reading the target data cached locally, and reads the target data cached locally only when the version number of the target data cached locally is consistent with the version number of the target data stored in a storage node. This mechanism reduces the load on the storage node, and ensures that the target data read locally is the latest value in the storage node. In this way, strong consistency of data is achieved.

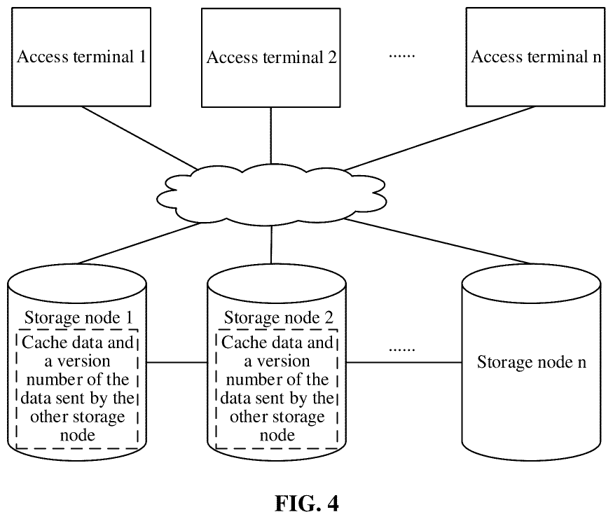

In some embodiments, data is cached in the access terminal, or is cached in another storage node. Referring to FIG. 4, some embodiments of the present disclosure provide a data access system, which includes at least one access terminal and at least two storage nodes. A value of n in FIG. 4 is an integer greater than 0. At least two storage nodes are in communication connection.

Any one of the storage nodes is configured to cache at least one piece of data and a version number of the at least one piece of data stored in this storage node in another storage node, and notify an access terminal; and/or receive at least one piece of data and a version number of the at least one piece of data sent by the other storage node, and store the at least one piece of data and the version number of the data locally, where a version number of any piece of data stored in the storage node is modified based on a modification operation performed on the piece of data.

Exemplarily, any storage node can notify some or all access terminals having access requirements for the piece of data after caching the at least one piece of data and the version number of the data of the storage node in the other storage node, to allow the access terminals having the access requirements for the piece of data to read the data from another storage node, thereby reducing the load on the present storage node.

Any access terminal is configured to send an access request to a storage node.

Any one of the storage nodes is further configured to receive an access request sent by any access terminal, and determine whether target data indicated by the access request is cached in the storage node by the other storage node; and return the target data to the access terminal in response to determining that the target data is not cached in the storage node by the other storage node; or return, in response to determining that the target data is cached in the storage node by the other storage node, the target data cached locally to the access terminal when it is determined that the version number of the target data stored in the storage node is consistent with the version number of the target data stored in the other storage node.

In some embodiments, data of a particular storage node can be stored in another storage node, and an access terminal can read target data from the other storage node. In this way, the load on the particular storage node is reduced. Furthermore, in view of the problem of invalidation of the target data stored in the other storage node caused by modification of the target data stored in the storage node, to avoid incorrect reading of the invalid target data from the other storage node by the access terminal, a version number check method is further provided. When the other storage node determines that the version number of the target data cached locally is consistent with the version number of the target data stored in the original storage node, which indicates that the cached target data is latest valid data, the other storage node can return the target data cached locally to the access terminal, thereby ensuring accuracy of data reading.

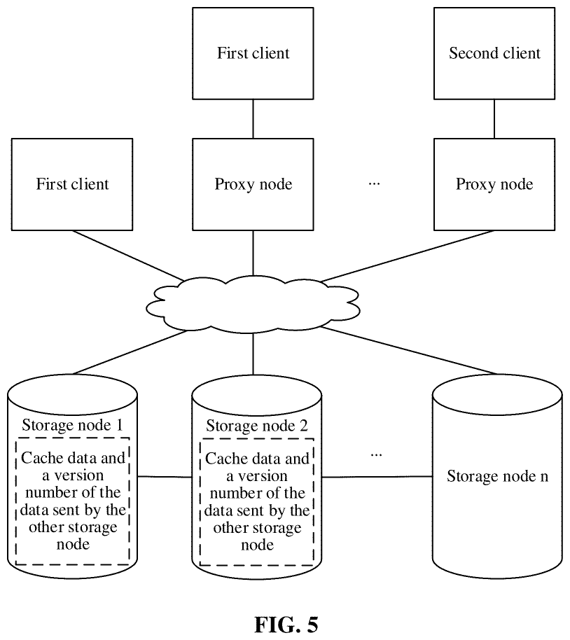

In some embodiments, referring to FIG. 5, the access terminal includes a proxy node and a first client. The proxy node is capable of communicating with the first client or a second client. Exemplarily, the proxy node can receive an access request sent by the first client, and forward the access request to a storage node; and return target data indicated by the access request to the first client after acquiring the target data indicated by the access request. Exemplarily, the proxy node can receive an access request sent by the second client, and forward the access request to a storage node; and return target data indicated by the access request to the second client after acquiring the target data indicated by the access request.

In some embodiments, after data of a particular storage node is stored in another storage node, the version number check process can be performed on any one of the two storage nodes. This is not limited in some embodiments.

In a possible implementation, any storage node is located on a device equipped with an RDMA network card. Any one of the storage nodes is further configured to cache at least one piece of data, a version number of the at least one piece of data, and a storage address of the version number of a storage node in the other storage node; and/or receive at least one piece of data, a version number of the at least one piece of data, and a storage address of the version number, which are sent by the other storage node, and store the at least one piece of data, the version number, and the storage address locally.

Any access terminal is configured to send an access request to a storage node.

Any one of the storage nodes is further configured to receive an access request sent by any access terminal, and determine whether target data indicated by the access request is cached in the storage node by the other storage node; and return the target data to the access terminal in response to determining that the target data is not cached in the storage node by the other storage node; or send a first check request to an RDMA network card of the other storage node through a local RDMA network card in response to determining that the target data is cached in the storage node by the other storage node, the first check request carrying a storage address of a version number of the target data, to allow the RDMA network card of the other storage node to read the version number of the target data from the storage address and return the version number; and return the target data cached locally to the access terminal when it is determined that the version number of the target data cached locally is consistent with the version number returned by the RDMA network card of the other storage node.

In some embodiments, through the RDMA technology, the RDMA network card of the other storage node directly reads the version number from the storage address and returns the version number without the need of a processor (such as a CPU) of the other storage node. In this way, the load on the processor of the other storage node (namely, an original storage node storing the target data) can be significantly reduced.

In some possible implementations, any storage node is configured to cache at least one piece of data and a version number of the at least one piece of data stored in this storage node in another storage node, and notify an access terminal; and/or receive at least one piece of data and a version number of the at least one piece of data sent by the other storage node, and store the at least one piece of data and the version number of the at least one piece of data locally, where the version number of any piece of data stored in the storage node is modified based on a modification operation performed on the piece of data.

Any access terminal is configured to send an access request to a storage node.

Any one of the storage nodes is further configured to receive an access request sent by any access terminal, and determine whether target data indicated by the access request is cached in the storage node by the other storage node; and return the target data to the access terminal in response to determining that the target data is not cached in the storage node by the other storage node; or send a second check request to the other storage node in response to determining that the target data is cached in the storage node by the other storage node, the second check request carrying a version number of the target data cached locally, to allow the other storage node to compare the version number of the target data carried in the second check request with the version number of the target data stored in the other storage node, and return consistency confirmation information when the version number of the target data carried in the second check request is consistent with the version number of the target data stored in the storage node. Any one of the storage nodes is further configured to return the target data cached locally to the access terminal according to the consistency confirmation information returned by the other storage node. In addition, when the other storage node returns inconsistency confirmation information, the storage node can delete the target data cached locally and the version number of the target data, re-acquire target data and a version number of the target data from the other storage node, store the target data and the version number of the target data locally, and return the target data to the access terminal.

In some embodiments, considering that particular data has low access frequency, caching such data in another storage node results in a low probability of subsequent access by the access terminal, thereby leading to a waste of storage resources of the other storage node. Furthermore, the other storage node also has a load problem. Therefore, any storage node is further configured to determine whether hot data exists in data of this storage node, cache the hot data and a version number of the hot data in the other storage node that satisfies low load conditions, and notify an access terminal; and/or receive hot data and a version number of the hot data, which are sent by the other storage node when load on the present storage node satisfies low load conditions, and store the hot data and the version number of the hot data locally. In some embodiments, hot data of a particular storage node is stored in another storage node with low load. In this way, the load on the storage node caused by hot data access is reduced, and load balancing is achieved.

The low load conditions can be specifically configured according to an actual application scenario. This is not limited in some embodiments. For example, a storage node 1 can first send a data storage request to a storage node 2 and a storage node 3, respectively; the storage node 2 determines that the load on the storage node 2 is high, and returns a first response indicating that the storage node 2 cannot store data to the storage node 1; the storage node 3 returns a second response indicating that the storage node 3 allows storage to the storage node 1 when it is determined that the load on the storage node 3 is low; and the storage node 1 can store hot data and a version number of the hot data in the storage node 3 based on the second response.

The hot data is data that can be accessed frequently. For example, an access count of the hot data within a unit time exceeds a preset threshold; or the access count of the hot data within the unit time is greater than a statistical value of an access count of other data within the unit time. The preset threshold can be specifically configured according to an actual application scenario. This is not limited in some embodiments. The statistical value of the access count includes, but is not limited to, an average value, a median value, a maximum value, or the like.

The present disclosure provides a data access system. Any storage node is configured to store at least one piece of data and a version number of each piece of data; and a version number of any piece of data is modified based on a modification operation performed on the piece of data. In this way, modification of the data and modification of the version number can be performed synchronously, to ensure the consistency. When determining that the target data indicated by the access request is cached in the storage node by the other storage node, the storage node performs version number check before reading the target data cached locally, and reads the target data cached locally only when the version number of the target data cached locally is consistent with the version number of the target data stored in the other storage node. This mechanism ensures that the read target data is the latest value in the other storage node. In this way, strong consistency of data is achieved.

The technical features in the foregoing implementations are combined in different ways, provided that no conflict or contradiction exists between combinations of the features. Due to space limitations, not all possible combinations are explicitly described here. Therefore, any combination of the technical features in the foregoing implementations still fall within the scope of the present disclosure.

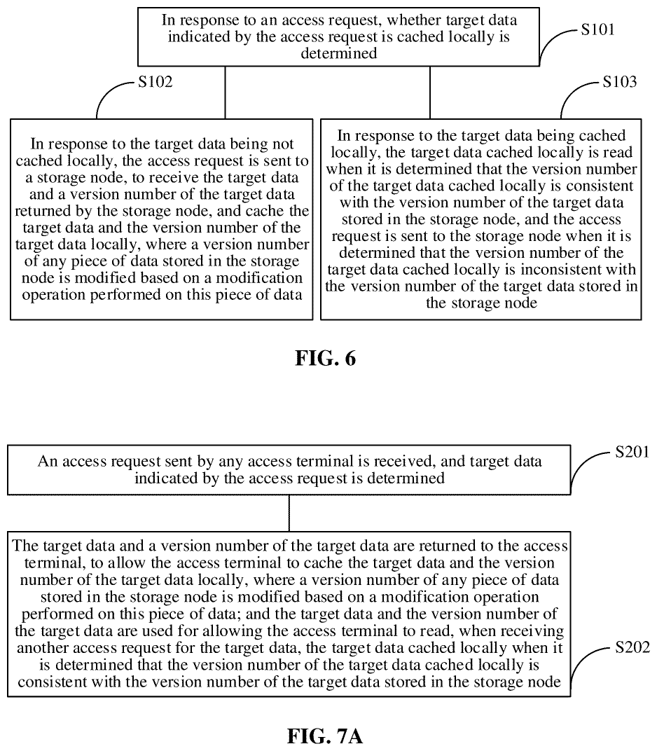

Correspondingly, referring to FIG. 6, some embodiments of the present disclosure further provide a data access method, which is applied to the access terminal shown in FIG. 1. The data access method includes the following steps.

In step S101, in response to an access request, whether target data indicated by the access request is cached locally is determined.

In step S102, in response to the target data being not cached locally, the access request is sent to a storage node, to receive the target data and a version number of the target data returned by the storage node, and cache the target data and the version number of the target data locally, where a version number of any piece of data stored in the storage node is modified based on a modification operation performed on this piece of data.

In step S103, in response to the target data being cached locally, the target data cached locally is read when it is determined that the version number of the target data cached locally is consistent with the version number of the target data stored in the storage node, and the access request is sent to the storage node when it is determined that the version number of the target data cached locally is inconsistent with the version number of the target data stored in the storage node.

In some embodiments, the access terminal is located on a device equipped with a first RDMA network card, and the storage node is located on a device equipped with a second RDMA network card.

The process of sending an access request to a storage node, to receive the target data and a version number of the target data returned by the storage node, and cache the target data and the version number of the target data locally includes: the access request is sent to the storage node, to receive the target data, the version number of the target data, and a storage address of the version number returned by the storage node, and cache the target data, the version number of the target data, and the storage address of the version number locally.

The process of reading the target data cached locally when it is determined that the version number of the target data cached locally is consistent with the version number of the target data stored in the storage node includes: a first check request is sent to the second RDMA network card through the first RDMA network card, the first check request carrying a storage address of the version number of the target data, to allow the second RDMA network card to read the version number of the target data stored in the storage node from the storage address and return the version number; and when it is determined that the version number of the target data cached locally is consistent with the version number returned by the second RDMA network card, the target data cached locally is read.

In some embodiments, the process of reading the target data cached locally when it is determined that the version number of the target data cached locally is consistent with the version number of the target data stored in the storage node includes: a second check request is sent to the storage node, the second check request carrying the version number of the target data cached locally, to allow the storage node to compare the version number of the target data carried in the second check request with the version number of the target data stored in the storage node, and consistency confirmation information is returned to the access terminal when the version number of the target data carried in the second check request is consistent with the version number of the target data stored in the storage node; and the target data cached locally is read according to the consistency confirmation information.

In some embodiments, the access terminal includes a proxy node and a first client.

The proxy node is capable of communicating with the first client or a second client, receiving an access request sent by the first client or the second client, and forwarding the access request to a storage node.

For specific content of the data access method, refer to the description of the foregoing data access system. Details are not described here again.

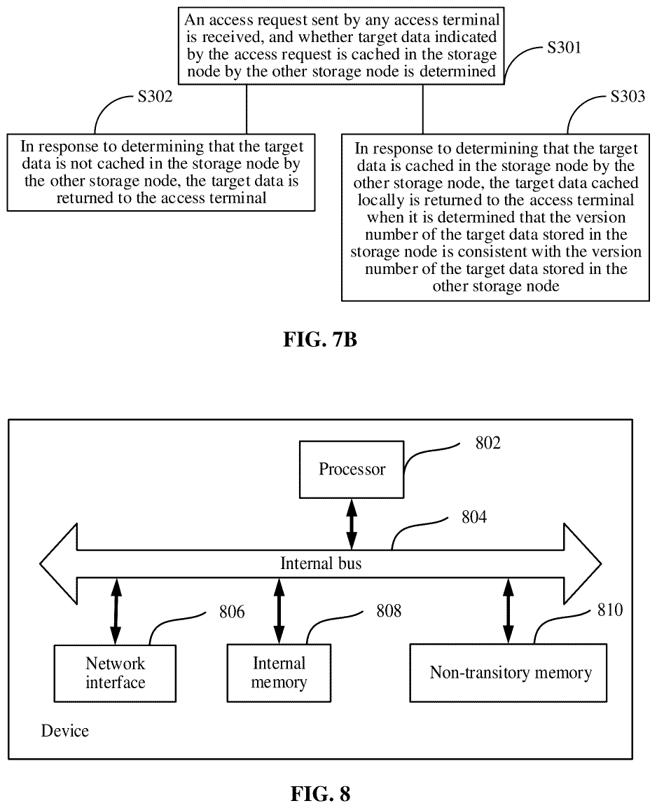

Correspondingly, referring to FIG. 7A, some embodiments of the present disclosure further provide a data access method, which is applied to the storage node shown in FIG. 1. The data access method includes the following steps.

In step S201, an access request sent by any access terminal is received, and target data indicated by the access request is determined.

In step S202, the target data and a version number of the target data are returned to the access terminal, to allow the access terminal to cache the target data and the version number of the target data locally, where a version number of any piece of data stored in the storage node is modified based on a modification operation performed on this piece of data; and the target data and the version number of the target data are used for allowing the access terminal to read, when receiving another access request for the target data, the target data cached locally when it is determined that the version number of the target data cached locally is consistent with the version number of the target data stored in the storage node.

In some embodiments, the access terminal is located on a device equipped with a first RDMA network card, and the storage node is located on a device equipped with a second RDMA network card. The access terminal is further configured to send a first check request to the second RDMA network card through the first RDMA network card, the first check request carrying a storage address of the version number of the target data; and the second RDMA network card is further configured to read the version number of the target data stored in the storage node from the storage address carried in the received first check request and return the version number.

In some embodiments, the data access method further includes: a second check request sent by any access terminal is received, the version number of the target data carried in the second check request is compared with the version number of the target data stored in the storage node, and consistency confirmation information is returned to the access terminal when the version number of the target data carried in the second check request is consistent with the version number of the target data stored in the storage node, to allow the access terminal to read the target data cached locally in the access terminal.

In some embodiments, the process of returning the target data and a version number of the target data to the access terminal includes: in response to the target data being hot data, the target data and the version number of the target data are returned to the access terminal, where an access count of the hot data within a unit time exceeds a preset threshold; or the access count of the hot data within the unit time is greater than a statistical value of an access count of other data within the unit time.

For specific content of the data access method, refer to the description of the foregoing data access system. Details are not described here again.

Correspondingly, referring to FIG. 7B, some embodiments of the present disclosure further provide a data access method, which is applied to the storage nodes shown in FIG. 4. Any one of the storage nodes is configured to cache at least one piece of data and a version number of the at least one piece of data stored in this storage node in another storage node, and notify an access terminal; and/or receive at least one piece of data and a version number of the at least one piece of data sent by the other storage node, and store the at least one piece of data and the version number of the data locally. A version number of any piece of data stored in the storage node is modified based on a modification operation performed on the piece of data. The data access method includes the following steps.

In step S301, an access request sent by any access terminal is received, and whether target data indicated by the access request is cached in the storage node by the other storage node is determined.

In step S302, in response to determining that the target data is not cached in the storage node by the other storage node, the target data is returned to the access terminal.

In step S303, in response to determining that the target data is cached in the storage node by the other storage node, the target data cached locally is returned to the access terminal when it is determined that the version number of the target data stored in the storage node is consistent with the version number of the target data stored in the other storage node.

In some embodiments, any storage node is located on a device equipped with an RDMA network card; and any storage node is further configured to cache at least one piece of data, a version number of the at least one piece of data, and a storage address of the version number of this storage node in another storage node; and/or receive at least one piece of data, a version number of the at least one piece of data, and a storage address of the version number, which are sent by another storage node, and store the at least one piece of data, the version number of the at least one piece of data, and the storage address of the version number locally.

The process of returning the target data cached locally to the access terminal when it is determined that the version number of the target data stored in the storage node is consistent with the version number of the target data stored in the other storage node includes the following steps. A first check request is sent to an RDMA network card of the other storage node through a local RDMA network card, where the first check request carries a storage address of the version number of the target data, to allow the RDMA network card of the other storage node to read the version number of the target data from the storage address and return the version number. When it is determined that the version number of the target data cached locally is consistent with the version number returned by the RDMA network card of the other storage node, the target data cached locally is returned to the access terminal.

In some embodiments, the process of returning the target data cached locally to the access terminal when it is determined that the version number of the target data stored in the storage node is consistent with the version number of the target data stored in the other storage node includes: a second check request is sent to the other storage node, where the second check request carries the version number of the target data cached locally, to allow the other storage node to compare the version number of the target data carried in the second check request with the version number of the target data stored in the other storage node, and return consistency confirmation information when the version number of the target data carried in the second check request is consistent with the version number of the target data stored in the storage node; and the target data cached locally is returned to the access terminal according to the returned consistency confirmation information.

In some embodiments, any storage node is configured to cache at least one piece of hot data and a version number of the hot data of this storage node in another storage node, and notify an access terminal; and/or receive at least one piece of hot data and a version number of the at least one piece of hot data, which are sent by another storage node, and store the at least one piece of hot data and the version number of the at least one piece of hot data locally. An access count of the hot data within a unit time exceeds a preset threshold; or the access count of the hot data within the unit time is greater than a statistical value of an access count of other data within the unit time.

For specific content of the data access method, refer to the description of the foregoing data access system. Details are not described here again.

The embodiments mentioned above achieve the following beneficial effects.

Version number check is performed before target data cached locally is read, and the target data cached locally is read when the version number of the target data cached locally is consistent with the version number of the target data stored in a storage node. This mechanism reduces the load on the storage node, and ensures that the target data read locally is the latest value in the storage node. In this way, strong consistency and accuracy of data are achieved.

A version number of any piece of data is modified based on a modification operation performed on the piece of data. In this way, modification of the data and modification of the version number can be performed synchronously, to maintain consistency. An access terminal performs version number check before reading target data cached locally, and reads the target data cached locally only when the version number of the target data cached locally is consistent with the version number of the target data stored in a storage node. This mechanism reduces the load on the storage node, and ensures that the target data read locally is the latest value in the storage node. In this way, strong consistency and accuracy of data are achieved.

Data is cached in another storage node, thereby reducing the access load on a present storage node. Furthermore, version number check needs to be performed before target data cached in another storage node is returned to an access terminal, and the target data is returned to the access terminal only when it is determined that the version numbers of the target data stored in the two storage nodes are consistent. In this way, strong consistency and accuracy of data are achieved.

FIG. 8 is a structural schematic diagram of a device according to some exemplary embodiments. Referring to FIG. 8, at a hardware level, the device includes a processor 802, an internal bus 804, a network interface 806, an internal memory 808, and a non-transitory memory 810. Certainly, the device may further include hardware required by another service. At least one embodiment of the present disclosure is implemented in the form of software. For example, the processor 802 reads a computer program from the non-transitory memory 810 into the internal memory 808 for executing the computer program. Certainly, in addition to the software implementation, at least one embodiment of the present disclosure does not exclude another implementation such as logic devices or a combination of hardware and software. That is, the executor of the following processing flow is not limited to logic units, and may alternatively be hardware or logic devices.

In some embodiments, the present disclosure further provides an electronic device, which includes: a processor; and a memory configured to store executable instructions of the processor, where the processor executes the executable instructions to implement the data access method according to any one of the foregoing embodiments.

In some embodiments, the present disclosure further provides a computer-readable storage medium, which stores computer instructions. The computer instructions, when executed by a processor, implement the steps of the data access method according to any one of the foregoing embodiments.

Exemplarily, the electronic device integrates a computer program product, and the electronic device executes the computer program product to implement the data access method according to the embodiments of the present disclosure.

It should be noted that all user information (including but not limited to user device information, personal information, and the like) and data (including but not limited to data for analysis, stored data, displayed data, and the like) that are involved in the present disclosure are information and data that are authorized by users or fully authorized by all parties. Furthermore, collection, use, and processing of relevant data shall comply with relevant laws, regulations, and standards of relevant countries and regions. Corresponding operation interfaces are provided to allow users to grant or refuse authorization.

The systems, apparatuses, modules, or units described in the foregoing embodiments are implemented specifically by computer chips or physical entities, or by products having particular functions. One typical implementation device is a computer. The computer may specifically take the form of a personal computer, laptop computer, cellular phone, camera phone, smartphone, personal digital assistant, media player, navigation device, email transceiver, game console, tablet computer, wearable device, or a combination of any several devices of these devices.

In a typical configuration, the computer includes at least one processor (CPU), an input/output interface, a network interface, and an internal memory.

The internal memory may include a non-persistent memory such as a random-access memory (RAM) and/or a non-transitory internal memory such as a read-only memory (ROM) or a flash memory (flash RAM), in the form of computer-readable media. The internal memory is an example of the computer-readable media.

The computer-readable media include both persistent and non-persistent, removable and non-removable media that may implement information storage through any method or technology. The information includes computer-readable instructions, data structures, program modules, or other data. Examples of the storage medium of the computer include, but are not limited to, a phase-change internal memory (PRAM), a static random-access memory (SRAM), a dynamic random-access memory (DRAM), other types of random-access memories (RAMs), a read-only memory (ROM), an electrically erasable programmable read-only memory (EEPROM), a flash memory or other internal memory technologies, a compact disc read-only memory (CD-ROM), a digital versatile disc (DVD) or other optical storage, a magnetic cassette, magnetic tape storage, a quantum memory, a graphene-based storage medium or other magnetic storage devices, or any other non-transmission media capable of being configured to store information accessible by computing devices. As defined herein, the computer-readable media exclude computer-readable transitory media (transitory media) such as modulated data signals and carrier waves.

It should be also noted that the term “contain”, “include”, or any variation thereof is intended to encompass non-exclusive inclusion, such that a process, method, article, or device including a list of elements not only includes those elements, but also includes other elements not expressly listed or inherent to such a process, method, article, or device. In the absence of further limitations, an element defined by the phrase “including one . . . ” does not exclude the existence of additional identical elements in a process, method, article, or device including the element.

Particular embodiments of the present disclosure are described above. Other embodiments fall within the scope of the appended claims. In some implementations, the actions or steps recited in the claims are performed in an order different from that described in the embodiments while still achieving the desired results. In addition, the processes depicted in the drawings do not necessarily require the particular order or sequential order shown to achieve the desired results. In particular implementations, multitasking and parallel processing are employed and may prove advantageous.

The terms used in at least one embodiment of the present disclosure are for the purpose of describing particular embodiments and are not intended to limit the scope of at least one embodiment of the present disclosure. The singular forms “a”, “an”, and “the” used in at least one embodiment of the present disclosure and the appended claims are intended to include plural references unless the context clearly indicates otherwise. It should also be understood that the term “and/or” used herein refers to and encompasses any and all possible combinations of at least one of the associated listed items.

It should be understood that although the terms “first”, “second”, “third”, and the like are used for describing various information in at least one embodiment of the present disclosure, the information should not be limited by these terms. These terms are used for distinguishing information of the same type from one another. For example, without departing from the scope of at least one embodiment of the present disclosure, first information may alternatively be referred to as second information, and similarly, second information may alternatively be referred to as first information. The word “if” as used herein is interpreted as “at the moment . . . ” or “when . . . ” or “in response to determining” depending on the context.

The above are exemplary embodiments of at least one embodiment of the present disclosure and are not intended to limit at least one embodiment of the present disclosure. Any modifications, equivalent substitutions, improvements, and the like made within the spirit and principles of at least one embodiment of the present disclosure shall fall within the scope of protection of at least one embodiment of the present disclosure.

1. A data access method, applied to an access terminal, the data access method comprising:
in response to an access request, determining whether target data indicated by the access request is cached locally;
in response to the target data being not cached locally, sending the access request to a storage node to receive the target data and a version number of the target data returned by the storage node, and cache the target data and the version number of the target data locally, wherein a version number of any piece of data stored in the storage node is modified based on a modification operation performed on this piece of data; and
in response to the target data being cached locally, reading the target data cached locally when it is determined that the version number of the target data cached locally is consistent with the version number of the target data stored in the storage node, and sending the access request to the storage node when it is determined that the version number of the target data cached locally is inconsistent with the version number of the target data stored in the storage node.

2. The data access method according to claim 1, wherein the access terminal is located on a device equipped with a first remote direct memory access (RDMA) network card, and the storage node is located on a device equipped with a second RDMA network card;
when sending the access request to the storage node, further receiving a storage address of the version number further returned by the storage node;
wherein reading the target data cached locally when it is determined that the version number of the target data cached locally is consistent with the version number of the target data stored in the storage node further comprises:
sending a first check request to the second RDMA network card through the first RDMA network card, the first check request carrying the storage address of the version number of the target data, to allow the second RDMA network card to read the version number of the target data stored in the storage node from the storage address and return the version number; and
reading the target data cached locally when it is determined that the version number of the target data cached locally is consistent with the version number returned by the second RDMA network card.

3. The data access method according to claim 1, wherein reading the target data cached locally when it is determined that the version number of the target data cached locally is consistent with the version number of the target data stored in the storage node comprises:
sending a second check request to the storage node, the second check request carrying the version number of the target data cached locally, wherein the second check request is used for allowing the storage node to compare the version number of the target data carried in the second check request with the version number of the target data stored in the storage node, and return consistency confirmation information to the access terminal when the version number of the target data carried in the second check request is consistent with the version number of the target data stored in the storage node; and
reading the target data cached locally according to the consistency confirmation information.

4. The data access method according to claim 1, wherein the access terminal comprises a proxy node and a first client; and
the proxy node is capable of communicating with the first client or a second client, receiving an access request sent by the first client or the second client, and forwarding the access request to a storage node.

5. A data access method, applied to a storage node, the data access method comprising:
receiving an access request sent by any access terminal, and determining target data indicated by the access request; and
returning the target data and a version number of the target data to the access terminal, to allow the access terminal to cache the target data and the version number of the target data locally, wherein a version number of any piece of data stored in the storage node is modified based on a modification operation performed on this piece of data; and
the target data and the version number of the target data are used for allowing the access terminal to read, when receiving another access request for the target data, the target data cached locally when it is determined that the version number of the target data cached locally is consistent with the version number of the target data stored in the storage node.

6. The data access method according to claim 5, wherein a device, where the access terminal is located, is equipped with a first RDMA network card, and a device, where the storage node is located, is equipped with a second RDMA network card;
the access terminal is further configured to send a first check request to the second RDMA network card through the first RDMA network card, the first check request carrying a storage address of the version number of the target data; and
the second RDMA network card is further configured to read the version number of the target data stored in the storage node from the storage address carried in the first check request and return the version number.

7. The data access method according to claim 5, further comprising:
receiving a second check request sent by any access terminal, comparing the version number of the target data carried in the second check request with the version number of the target data stored in the storage node, and returning consistency confirmation information to the access terminal when the version number of the target data carried in the second check request is consistent with the version number of the target data stored in the storage node, to allow the access terminal to read the target data cached locally in the access terminal.

8. The data access method according to claim 5, wherein returning the target data and the version number of the target data to the access terminal comprises:
returning the target data and the version number of the target data to the access terminal in response to the target data being hot data;
wherein an access count of the hot data within a unit time exceeds a preset threshold; or the access count of the hot data within the unit time is greater than a statistical value of access counts of other data within the unit time.

9. A data access method, applied to a storage node, any storage node, configured to cache at least one piece of data and a version number of the at least one piece of data stored in this storage node in another storage node, and notify an access terminal; and/or receive at least one piece of data and a version number of the at least one piece of data sent by the other storage node, and store the at least one piece of data and the version number locally; a version number of any piece of data stored in the storage node being modified based on a modification operation performed on this piece of data; and the data access method comprises:
receiving an access request sent by any access terminal, and determining whether target data indicated by the access request is cached in the storage node by the other storage node;
returning the target data to the access terminal in response to determining that the target data is not cached in the storage node by the other storage node; and
returning, in response to determining that the target data is cached in the storage node by the other storage node, the target data cached locally to the access terminal when it is determined that the version number of the target data stored in the storage node is consistent with the version number of the target data stored in the other storage node.

10. The data access method according to claim 9, wherein a device, where any storage node is located, is equipped with an RDMA network card;
any storage node is further configured to cache a storage address of the version number in the other storage node; and/or receive a storage address of a version number sent by the other storage node, and store the storage address locally; and
returning the target data cached locally to the access terminal when it is determined that the version number of the target data stored in the storage node is consistent with the version number of the target data stored in the other storage node comprises:
sending a first check request to an RDMA network card of the other storage node through the RDMA network card, the first check request carrying a storage address of the version number of the target data, to allow the RDMA network card of the other storage node to read the version number of the target data from the storage address, and return the version number; and
returning the target data cached locally to the access terminal when it is determined that the version number of the target data cached locally is consistent with the version number returned by the RDMA network card of the other storage node.

11-14. (canceled)

15. The data access method according to claim 2, wherein the access terminal comprises a proxy node and a first client; and
the proxy node is capable of communicating with the first client or a second client, receiving an access request sent by the first client or the second client, and forwarding the access request to a storage node.

16. The data access method according to claim 3, wherein the access terminal comprises a proxy node and a first client; and
the proxy node is capable of communicating with the first client or a second client, receiving an access request sent by the first client or the second client, and forwarding the access request to a storage node.

17. The data access method according to claim 4, wherein the proxy node is capable of returning the target data to the first client after acquiring the target data indicated by the access request sent by the first client, and returning the target data to the second client after acquiring the target data indicated by the access request sent by the second client.

18. The data access method according to claim 5, wherein the data access method further comprises:
receiving a second check request sent by any access terminal, comparing the version number of the target data carried in the second check request with the version number of the target data stored in the storage node, and returning inconsistency confirmation information to the access terminal when the version number of the target data carried in the second check request is inconsistent with the version number of the target data stored in the storage node, to allow the access terminal to send an access request to this storage node.

19. The data access method according to claim 5, wherein the storage node is configured to determine whether target data indicated by the access request is hot data after receiving the access request sent by any access terminal.

20. The data access method according to claim 8, wherein the statistical value of access counts of other data comprises an average value, a median value, and a maximum value.

21. The data access method according to claim 8, wherein the data access method further comprises:
returning the target data to the access terminal in response to the target data not being the hot data.

22. The data access method according to claim 9, wherein returning the target data cached locally to the access terminal when it is determined that the version number of the target data stored in the storage node is consistent with the version number of the target data stored in the other storage node comprises:
sending a second check request to the other storage node, the second check request carrying a version number of the target data cached locally, to allow the other storage node to compare the version number of the target data carried in the second check request with the version number of the target data stored in the other storage node, and return consistency confirmation information when the version number of the target data carried in the second check request is consistent with the version number of the target data stored in the storage node; and
returning the target data cached locally to the access terminal according to the consistency confirmation information returned by the other storage node.

23. The data access method according to claim 9, wherein the data access method further comprises:
deleting the target data cached locally and the version number of the target data when it is determined that the version number of the target data stored in the storage node is inconsistent with the version number of the target data stored in the other storage node;
re-acquiring target data and a version number of the target data from the other storage node, and storing the target data and the version number of the target data locally; and
returning the target data to the access terminal.

24. The data access method according to claim 9, wherein any storage node is configured to determine whether hot data exists in data of this storage node, cache the hot data and a version number of the hot data in the other storage node that satisfies low load conditions in response to the hot data existing in data of this storage node, and notify the access terminal;
wherein an access count of the hot data within a unit time exceeds a preset threshold; or the access count of the hot data within the unit time is greater than a statistical value of access counts of other data within the unit time.
